(19) United States
(12) Patent Application Publication
(10) Pub. No.: US 2025/0063514 A1
(43) Pub. Date: Feb. 20, 2025

(54) CONTROL DEVICE, CONTROL METHOD, AND BASE STATION APPARATUS

(71) Applicant: Fujitsu Limited, Kawasaki-shi Kanagawa (JP)

(72) Inventors: Ryota KOSAKA, Kawasaki (JP); Takashi SEYAMA, Kawasaki (JP)

(73) Assignee: Fujitsu Limited, Kawasaki-shi Kanagawa (JP)

(21) Appl. No.: 18/772,387

(22) Filed: Jul. 15, 2024

(30) Foreign Application Priority Data
Aug. 16, 2023 (JP) 2023-132589

(51) Int. Cl. H04W 52/24; H04W 52/10

(52) U.S. Cl. CPC H04W 52/243; H04W 52/10; H04W 52/242

(57) ABSTRACT

A control device in a communication system that includes base stations each to constitute a cell, and a terminal to perform wireless communication with the base station when the terminal is positioned in the cell, the control device controlling the base stations, includes a memory, and processor circuitry coupled to the memory and configured to acquire, from the base station, an interference value measured when a signal is received from the terminal by the base station, estimate, when a transmission power of a first terminal that communicates with a first base station is controlled in accordance with a value of a path loss for the first base station, a maximum-given-interference-amount, among given-interferences of the first terminal for an other base station other than the first base station, and acquire a corrected value for correcting the transmission power of the first terminal by using the maximum-given-interference-amount.

### CROSS-REFERENCE TO RELATED APPLICATION

This application is based upon and claims the benefit of priority of the prior Japanese Patent Application No. 2023-132589, filed on Aug. 16, 2023, the entire contents of which are incorporated herein by reference.

### FIELD

Embodiments discussed herein are related to a control device, a control method, and a base station apparatus.

### BACKGROUND

In a wireless communication system, a base station apparatus constructs a communication area (hereafter, may be referred to as a cell) in which the base station apparatus may perform wireless communication with a terminal apparatus. For example, in a case where the terminal apparatus is positioned at a cell edge, since a power of a radio wave received by a base station apparatus in an own cell is low in uplink communication, an interference occurs with a radio wave of a terminal apparatus in an other cell. Thus, a signal-to-interference noise ratio (SINR) decreases or throughput decreases. Thus, in the wireless communication system, to reduce the interference from the terminal apparatus in the other cell, transmission power control (TPC) may be performed.

As the TPC, for example, there is a method called open-loop TPC (OLTPC). The OLTPC is TPC in which the closer the terminal apparatus is to the base station apparatus in the own cell, the lower a transmission power is made.

However, since the terminal apparatus close to the base station apparatus in the own cell is far from a base station apparatus in an other cell, a given interference for the terminal apparatus in the other cell is small. In the OLTPC, since control for decreasing the transmission power is performed for the terminal apparatus close to the base station apparatus in the own cell, despite the fact that the given interference is small, throughput may deteriorate. On the other hand, in the OLTPC, although the terminal apparatus positioned at the cell edge has a high transmission power, since the given interference for the terminal apparatus in the other cell also increases, throughput may be improved as a whole by decreasing the transmission power to reduce the given interference.

Therefore, in addition to the control in the OLTPC, the given interference for the other cell may be suppressed by determining the transmission power by using a corrected value in consideration of a path loss in the other cell.

A communication system in consideration of the given interference for the other cell is described in, for example, documents of the related art.

Japanese Laid-open Patent Publication Nos. 2013-90164 and 2010-166604 are disclosed as related art.

M. Boussif, N. Quintero, F. D. Calabrese, C. Rosa, and J. Wigard, “Interference Based Power Control Performance in LTE Uplink”, in Proc. of 2008 IEEE International Symposium on Wireless Communication System, pp. 698-702, 2008 is also disclosed as related art.

### SUMMARY

According to an aspect of the embodiments, a control device in a communication system that includes a plurality of base station apparatuses each to constitute a cell, and a terminal apparatus to perform wireless communication with the base station apparatus when the terminal apparatus is positioned in the cell, the control device controlling the base station apparatuses, the control device includes a memory, and a processor coupled to the memory and configured to acquire, from the base station apparatus, an interference value measured when a signal is received from the terminal apparatus by the base station apparatus, estimate, when a transmission power of a first terminal apparatus that communicates with a first base station apparatus of the plurality of base station apparatuses is controlled in accordance with a value of a path loss for the first base station apparatus, a maximum given interference amount which is a maximum amount, among given interferences of the first terminal apparatus for an other base station apparatus other than the first base station apparatus, and acquire a corrected value for correcting the transmission power of the first terminal apparatus by using the maximum given interference amount.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram illustrating a configuration example of a wireless communication system;

FIG. 2 is a diagram illustrating a configuration example of a radio access network intelligent controller (RIC);

FIG. 3 is a diagram illustrating a configuration example of the wireless communication system;

FIG. 4 is a diagram illustrating a configuration example of a base station apparatus;

FIG. 5 is a diagram illustrating examples of equations used in OLTPC;

FIG. 6 is a diagram illustrating an example of a software configuration of the wireless communication system;

FIG. 7 is a diagram illustrating an example of a given interference in the wireless communication system;

FIG. 8 is a diagram illustrating examples of equations in second corrected value calculation;

FIG. 9 is a diagram illustrating an example of a processing flowchart of transmission output control processing in the RIC;

FIG. 10 is a diagram illustrating examples of equations used in transmission power control;

FIG. 11 is a diagram illustrating examples of equations used in the transmission power control;

FIG. 12 is a diagram illustrating an example of a software configuration of a wireless communication system according to a modification example of the first embodiment;

FIG. 13 is a diagram illustrating an example of a software configuration of a wireless communication system according to a second embodiment;

FIG. 14 is a diagram illustrating an example of radio wave measurement in a terminal apparatus of the wireless communication system;

FIG. 15 is a diagram illustrating an example of a processing flowchart of transmission power control in a base station apparatus;

FIG. 16 is a diagram illustrating examples of equations used in second corrected value calculation; and

FIG. 17 is a diagram illustrating an example of a software configuration of a wireless communication system according to a modification example of the second embodiment.

### DESCRIPTION OF EMBODIMENTS

A method for calculating or estimating the path loss in the other cell to be used in calculation of this corrected value has not been determined. For example, when the path loss is measured in a combination of all terminal apparatuses and all base station apparatuses, a measurement time period or a processing load increases, and thus, real-time performance of the transmission power control may not be ensured.

Embodiments of techniques to efficiently perform transmission power control of a terminal apparatus will be described in detail with reference to the drawings.

### First Embodiment

### [About Wireless Communication System 1]

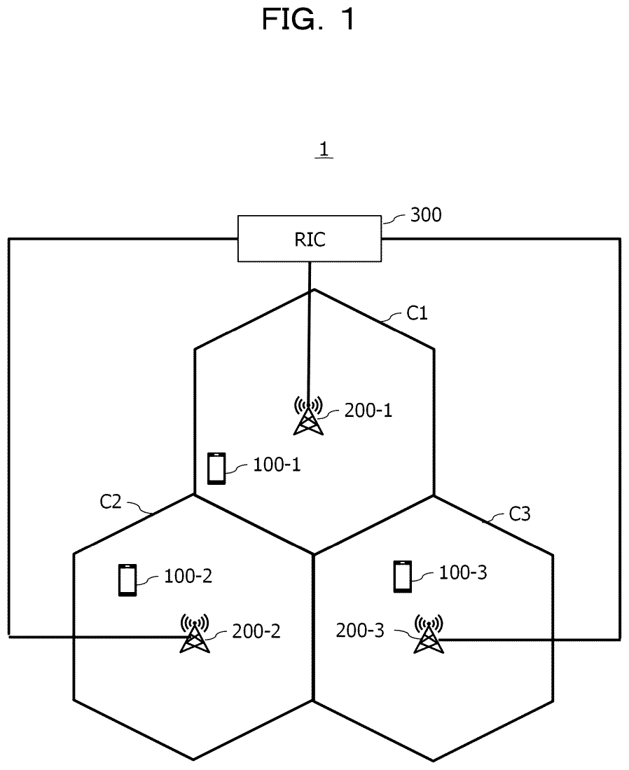

FIG. 1 is a diagram illustrating a configuration example of a wireless communication system 1. The wireless communication system 1 includes a radio access network intelligent controller (RIC) 300, base station apparatuses 200-1 to 200-3, and terminal apparatuses 100-1 to 100-3. The wireless communication system 1 is a system in which the RIC 300 performs transmission output control (TPC) of the terminal apparatuses 100-1 to 100-3 via the base station apparatuses 200-1 to 200-3.

Each of the base station apparatuses 200-1 to 200-3 (hereafter, may be referred to as a base station apparatus 200) is an apparatus that performs wireless communication with each of the terminal apparatuses 100-1 to 100-3 (hereafter, may be referred to as a terminal apparatus 100), and is, for example, an eNodeB or a gNodeB. The base station apparatus 200 may be constituted by one unit, or may be constituted by a plurality of units such as a central unit (CU) and a distributed unit (DU). The base station apparatus 200 constitutes a communication area (cell) that is an area in which the terminal apparatus 100 performs wireless communication with the base station apparatus 200. The base station apparatuses 200-1 to 200-3 constitute cells C1 to C3, respectively. Although the cells C1 to C3 do not overlap each other in FIG. 1, the cells C1 to C3 may overlap each other.

The terminal apparatus 100 is a communication apparatus that performs wireless communication by being wirelessly coupled to the base station apparatus 200, and examples thereof include a wireless communication device such as a smartphone or a tablet terminal. Since the terminal apparatus 100-1 is positioned in the cell C1, the terminal apparatus 100-1 performs wireless communication with the base station apparatus 200-1. The terminal apparatus 100-2 and the terminal apparatus 100-3 perform wireless communication with the base station apparatus 200-2 and the base station apparatus 200-3, respectively. Each of the terminal apparatuses 100-1 to 100-3 may move. The terminal apparatuses 100-1 to 100-3 may perform communication with an other base station apparatus 200.

The RIC 300 is a control device that controls the base station apparatus 200 and the terminal apparatus 100, and is, for example, a server machine or a computer. The RIC 300 performs transmission output control (TPC) of the terminal apparatus 100. The RIC 300 acquires a measurement result of radio waves from the base station apparatus 200. For example, the base station apparatus 200 receives a signal from the terminal apparatus 100 in the own cell and/or an other cell, and performs measurement. Examples of a measured value include a value related to received power (for example, Reference Signal Received Power: RSRP), a value related to interference (for example, signal-to-interference noise ratio (SINR)), and the like. Based on the measurement result, the RIC 300 periodically or non-periodically performs transmission output control.

### [Configuration Example of RIC 300]

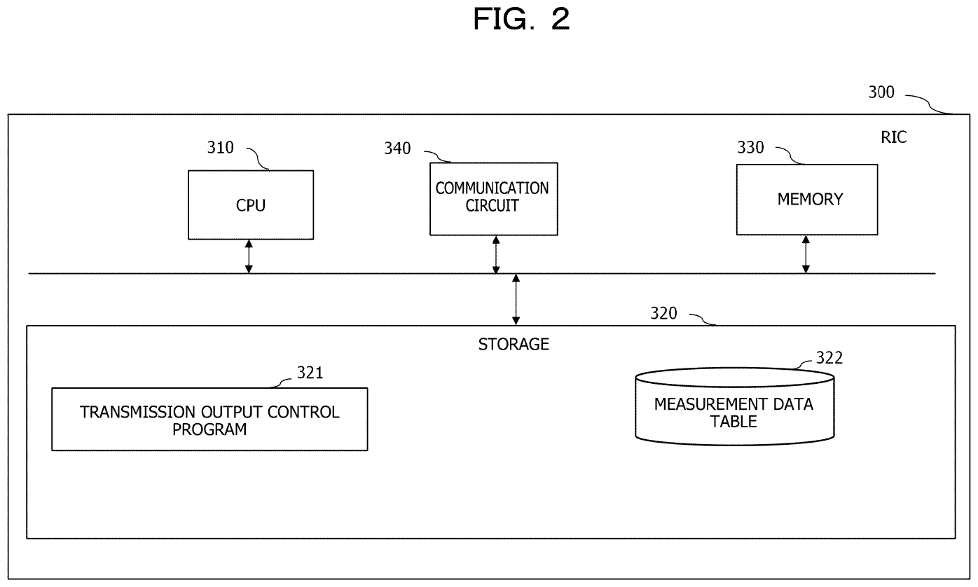

FIG. 2 is a diagram illustrating a configuration example of the RIC 300. The RIC 300 includes a central processing unit (CPU) 310, a storage 320, a memory 330, and a communication circuit 340.

The storage 320 is an auxiliary storage device, such as a flash memory, a hard disk drive (HDD), or a solid-state drive (SSD), for storing programs and data. The storage 320 stores a transmission output control program 321 and a measurement data table 322.

The measurement data table 322 is a table that stores measured values of wireless states measured by the base station apparatus 200. The RIC 300 stores the measured values acquired from the base station apparatus 200 in the measurement data table 322, and refers to the measured values in transmission output control processing.

The memory 330 is an area into which the programs stored in the storage 320 are loaded. The memory 330 may be used as an area in which the programs store data.

The communication circuit 340 is a device that performs communication with the base station apparatus 200. The base station apparatus 200 and the RIC 300 are coupled to each other in a wired manner via the communication circuit 340.

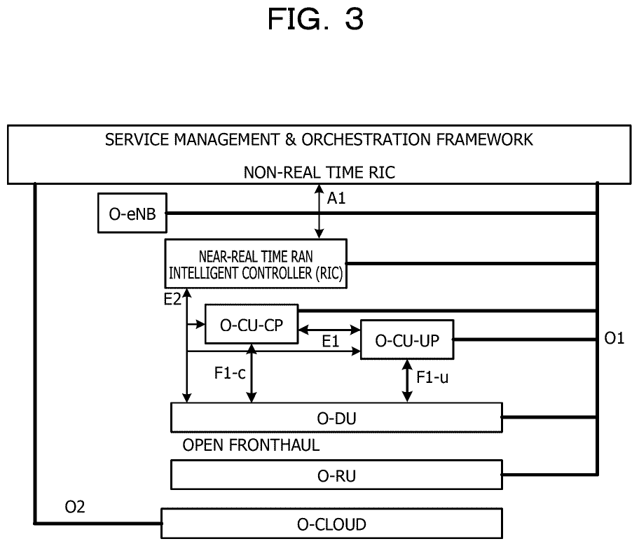

FIG. 3 is a diagram illustrating a configuration example of the wireless communication system 1. FIG. 3 is an example of a wireless communication system defined by an open interface, and is an extract of “FIG. 3.3.3-1: Flat Model” of “0-RAN.WG1.OAM-Architecture-v04.00”. For example, the RIC is standardized by “O-RAN ALLIANCE” and is a device that controls and optimizes a RAN function. As illustrated in FIG. 3, the RIC 300 is, for example, “Non-Real Time RIC” or “Near-Real Time RAN Intelligent Controller (RIC)”. In FIG. 3, the base station apparatus 200 is “O-CU-CP”, “O-CU-UP”, “O-DU”, and “O-RU”.

In a case where the RIC 300 is “Near-Real Time RAN Intelligent Controller (RIC)”, communication with the base station apparatus 200 is performed over an E2 interface.

In a case where the RIC 300 is “Non-Real Time RIC”, the communication with the base station apparatus 200 is performed via “Near-Real Time RAN Intelligent Controller (RIC)”. The communication between the RIC 300 and the “Near-Real Time RAN Intelligent Controller (RIC)” is performed over an A1 interface, and communication between the “Near-Real Time RAN Intelligent Controller (RIC)” and the base station apparatus 200 is performed over the E2 interface.

Referring back to FIG. 2, the CPU 310 is a processor that loads the program stored in the storage 320 into the memory 330, executes the loaded program, constructs each unit, and implements each processing.

By executing the transmission output control program 321, the CPU 310 constructs, for example, a control unit and a sharing unit to perform the transmission output control processing. The transmission output control processing is processing of controlling a transmission output of the terminal apparatus 100. In the transmission output control processing, the RIC 300 acquires a wireless measured value from each base station apparatus 200, calculates the transmission output of the terminal apparatus 100 based on the measured value, and controls the transmission output of the terminal apparatus 100 via the base station apparatus 200. [Configuration Example of Base Station Apparatus 200]

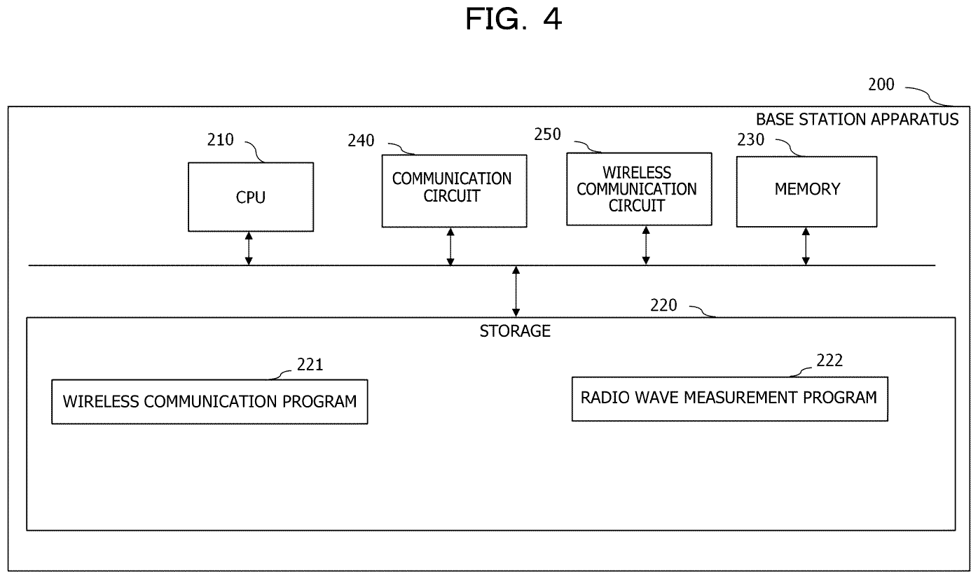

FIG. 4 is a diagram illustrating a configuration example of the base station apparatus 200. The base station apparatus 200 includes a CPU 210, a storage 220, a memory 230, a communication circuit 240, and a wireless communication circuit 250.

The storage 220 is an auxiliary storage device, such as a flash memory, an HDD, or an SSD, for storing programs and data. The storage 220 stores a wireless communication program 221 and a radio wave measurement program 222.

The memory 230 is an area into which the programs stored in the storage 220 are loaded. The memory 230 may be used as an area into which the programs store data.

The communication circuit 240 is a device that performs communication with the RIC 300. The base station apparatus 200 and the RIC 300 are coupled to each other in a wired manner via the communication circuit 240.

The wireless communication circuit 250 is a device that performs wireless communication with the terminal apparatus 100. For example, the wireless communication circuit 250 includes an antenna and transmits and receives radio waves (signals) to and from the terminal apparatus 100.

The CPU 210 is a processor that loads the program stored in the storage 220 into the memory 230, executes the loaded program, constructs each unit, and implements each processing.

By executing the wireless communication program 221, the CPU 210 constructs, for example, a measurement unit, an acquisition unit, a control unit, and an estimation unit to perform wireless communication processing. The wireless communication processing is processing of controlling the wireless communication with the terminal apparatus 100. In the wireless communication processing, the base station apparatus 200 gives an instruction about a transmission output to the terminal apparatus 100 and notifies the terminal apparatus 100 of a corrected value.

By executing the radio wave measurement program 222, the CPU 210 constructs, for example, a measurement unit to perform radio wave measurement processing. The radio wave measurement processing is to measure received power and a degree of interference when signals are received from the terminal apparatus 100 in the own cell and the terminal apparatus 100 in an other cell in the radio wave measurement processing.

### [OLTPC]

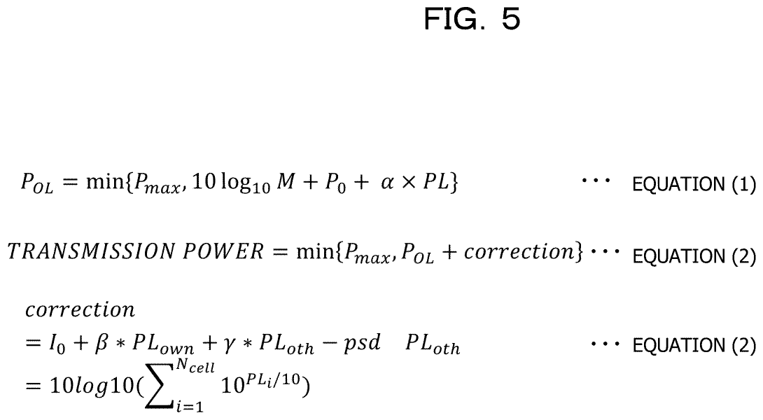

OLTPC and a correction way of the transmission power will be described. FIG. 5 is a diagram illustrating an example of equations used in the OLTPC and the correction way.

Equation (1) is an equation for calculating the transmission output of the terminal apparatus 100 in the OLTPC. P_{OL} is a transmission output of the terminal apparatus 100. Pₘₐₓ is a maximum transmission power of the terminal apparatus 100. M is the number of resource blocks allocated to the terminal apparatus 100. P₀ is a target received power. α is a path loss compensation coefficient. PL is a path loss. The base station apparatus 200 notifies the terminal apparatus 100 of P₀ and a in advance. PL is a value calculated from a reference signal received on the terminal apparatus 100 side.

Equation (2) is an equation for calculating a transmission output when there is a corrected value. correction is a corrected value.

Equation (3) is an equation for calculating a corrected value. PL_{own} is a path loss of the own cell, and PLₒₜₕ is a total sum of path losses PLᵢ of adjacent cells (other cells). I₀ is an arbitrary interference upper limit value. psd is a transmission power per 1 resource block (RB) at a latest time when the terminal apparatus 100 performs communication. β and γ are weights (coefficients). i is an identifier (ID) of an adjacent cell. N_{cell} is a total number of adjacent cells. β+γ=1 holds. It is assumed that a unit of each value is represented in dB notation.

As represented in Equations (1) to (3), the transmission output is calculated by using the OLTPC and the correction way. Although a value of an interference (given interference) is used in Equation (2), in many cases, the RIC 300 may not acquire (estimate or calculate) a value of a given interference for each cell from each terminal apparatus 100.

Therefore, in some cases, the RIC 300 calculates a second corrected value calculated in a second corrected value calculation method to be described below, instead of the corrected value.

### [Software Configuration]

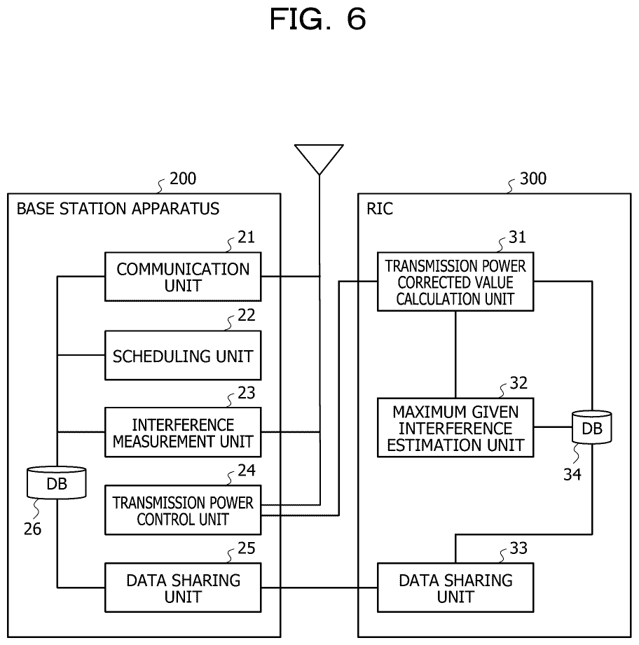

A software configuration of the wireless communication system 1 will be described. FIG. 6 is a diagram illustrating an example of the software configuration of the wireless communication system 1. It is assumed that the units are constructed by the processors included in the base station apparatus 200 and the RIC 300 executing the programs.

The base station apparatus 200 includes a communication unit 21, a scheduling unit 22, an interference measurement unit 23, a transmission power control unit 24, a data sharing unit 25, and a database (DB) 26.

The communication unit 21 performs wireless communication with the terminal apparatus 100. The communication unit 21 performs notification of a parameter in transmission power control, reception of the measured value, storage of the received value in the DB 26, and the like.

The scheduling unit 22 performs resource management for the terminal apparatus 100 and controls a communication timing and a resource block of the terminal apparatus 100.

The interference measurement unit 23 measures an interference power from the terminal apparatus 100 in an other cell and stores the interference power in the DB 26. For example, the interference measurement unit 23 receives a pilot signal transmitted by the terminal apparatus 100, and measures the interference power at the time of reception.

According to an instruction from the RIC 300, the transmission power control unit 24 gives, to the terminal apparatus 100, a notification by using a TPC command or the like so that the terminal apparatus 100 has the instructed transmission power.

The data sharing unit 25 transmits various kinds of data stored in the DB 26 to a data sharing unit 33 of the RIC 300.

The DB 26 is a storage unit that stores various kinds of data.

The RIC 300 includes a transmission power corrected value calculation unit 31, a maximum given interference estimation unit 32, the data sharing unit 33, and a DB 34.

The transmission power corrected value calculation unit 31 calculates a second corrected value from a maximum given interference of a certain terminal apparatus 100. The transmission power corrected value calculation unit 31 notifies the terminal apparatus 100 of the second corrected value.

The maximum given interference estimation unit 32 estimates a maximum given interference given to an adjacent cell by a certain terminal apparatus 100.

The data sharing unit 33 stores, in the DB 34, data received from the base station apparatus 200 and data calculated and estimated by the RIC 300.

The DB 34 is a storage unit that stores various kinds of data.

### [Second Corrected Value Calculation Method]

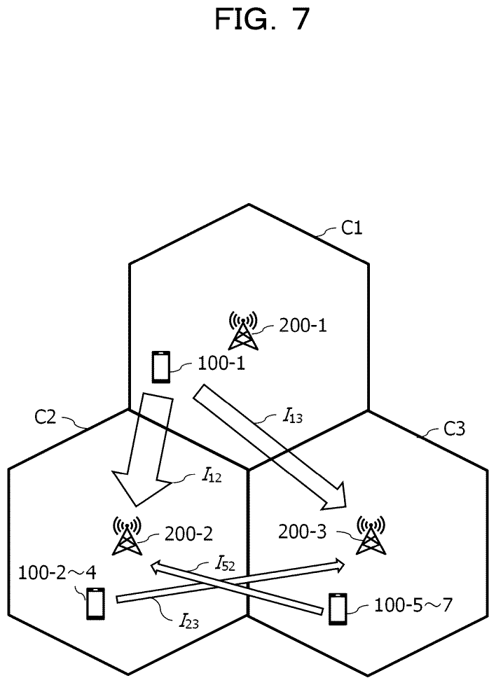

A method for calculating the second corrected value will be described. FIG. 7 is a diagram illustrating an example of the given interference in the wireless communication system 1. Iᵢⱼ indicates, for example, the given interference given to a cell Cj by a terminal apparatus 100-i. It is assumed that each of arrows I₁₂ to I₅₂ indicates a given interference given to an adjacent cell by each terminal apparatus 100, and the thicker the arrow, the larger the given interference. CIᵢⱼ indicates a total interference amount (total interference power) of the cell Cj that includes Iᵢⱼ.

As illustrated in FIG. 7, it is assumed that the terminal apparatus 100-1 is positioned in the cell C1, terminal apparatuses 100-2 to 100-4 are positioned in the cell C2, and terminal apparatuses 100-5 to 100-7 are positioned in the cell C3. Suppose that the terminal apparatus 100-1 communicates at all times in the cell C1, the terminal apparatuses 100-2, 100-3, and 100-4 communicate in this order in the cell C2, and the terminal apparatuses 100-5, 100-6, and 100-7 communicate in this order in the cell C3.

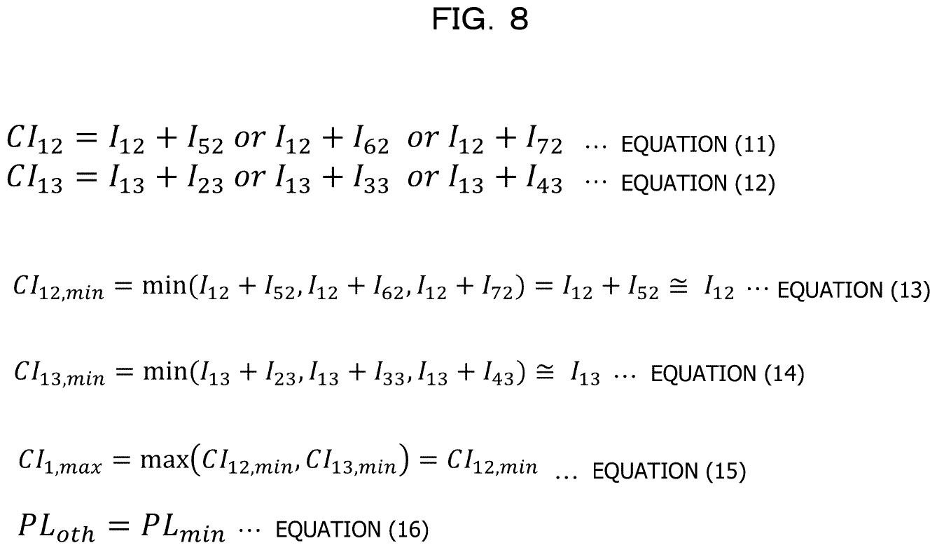

FIG. 8 is a diagram illustrating an example of equations in second corrected value calculation. Hereinafter, the second corrected value calculation method will be described with reference to FIGS. 7 and 8.

Total interference amounts received by the cell C2 and the cell C3 are represented by Equation (11) and Equation (12), respectively. “or” included in Equation (11) and Equation (12) represents a difference depending on the timing.

For the RIC 300, minimum values (CI_{12, min} and CI_{13, min}) of CI₁₂ and CI₁₃ are calculated by using Equation (13) and Equation (14), respectively. As represented in Equation (13) and Equation (14), the RIC 300 regards the minimum values of CI₁₂ and CI₁₃ as I₁₂ and I₁₃, respectively.

For example, in a case where I₁₂ is sufficiently larger than any of other I₅₂, I₆₂, and I₇₂, CI_{12, min} is approximated to I₁₂. Even though the above condition is not satisfied, in a case where there are a large number of terminal apparatuses 100 and there are a large number of combinations of CI₁₂, since any I₁₂ is sufficiently small, it is highly likely that CI_{12, min} is approximated to I₁₂. Accordingly, as represented in Equation (13) and Equation (14), the RIC 300 may regard CI_{12, min} and CI_{13, min} as I₁₂ and I₁₃, respectively.

By using Equation (15), the RIC 300 calculates a maximum given interference (CI_{1, max}) of the terminal apparatus 100-1. Since the maximum given interference is larger one of CI_{12, min} and CI_{13, min} and I₁₂ is larger than I₁₃ (thicker arrow) in the case of FIG. 7, the maximum given interference is calculated (estimated) as CI_{12, min}.

The maximum given interference is subtracted from the transmission power of the terminal apparatus 100-1, and thus, a path loss for a maximum given interference cell may be estimated. The path loss calculated (estimated) by using the maximum given interference is represented by PLₘᵢₙ.

The RIC 300 calculates the second corrected value by using Equation (3) for calculating the corrected value in FIG. 5. However, PLₘᵢₙ is used for the PLₒₜₕ in Equation (3) in FIG. 5 (see Equation (16)).

In the calculation of the corrected value of the OLTPC, the RIC 300 calculates the corrected value by using only the maximum given interference for the adjacent cell instead of using a total value of given interferences for the cells. Accordingly, for example, even in a case where all the given interferences in all the cells may not be measured or in a case where a time period or a processing amount is used to estimate the total value of the given interferences, since only the maximum given interference may be calculated, the corrected value (second corrected value) may be efficiently calculated.

### [Transmission Power Control Processing]

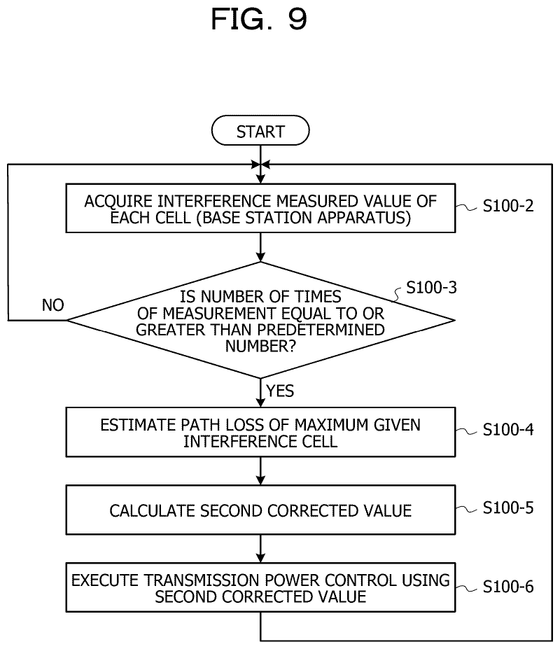

The transmission power control processing will be described. FIG. 9 is a diagram illustrating an example of a processing flowchart of transmission output control processing S100 in the RIC 300.

For example, transmission output control processing S100 is processing executed after the OLTPC (Equation (1) in FIG. 5) is performed in the terminal apparatus 100, and is processing of performing corrected value calculation and notification.

The RIC 300 acquires measurement data in each cell (base station apparatus 200) (S100-2). The measurement data is data stored in the base station apparatus 200, and includes, for example, a degree of interference (SINR), received power (RSRP), a path loss estimated value, the number of resource blocks, and the like. For example, the measurement data is stored in association with a time. The RIC 300 stores the acquired measurement data for each terminal apparatus 100 (in association with each other).

In a case where the number of times of measurement in the base station apparatus 200 is not equal to or greater than a predetermined number of times (No in S100-3), the RIC 300 waits for next measurement in the base station apparatus 200 and acquires a measured value (S100-2). The RIC 300 repeats this processing until the number of times of measurement reaches the predetermined number of times.

In a case where the number of times of measurement in the base station apparatus 200 is equal to or greater than the predetermined number of times (Yes in S100-3), the RIC 300 estimates the path loss of the maximum given interference cell (S100-4).

The RIC 300 calculates the second corrected value by using the estimated path loss of the maximum given interference cell (S100-5), and performs the transmission power control using the second corrected value (S100-6). Thereafter, the RIC 300 periodically or non-periodically repeats this processing.

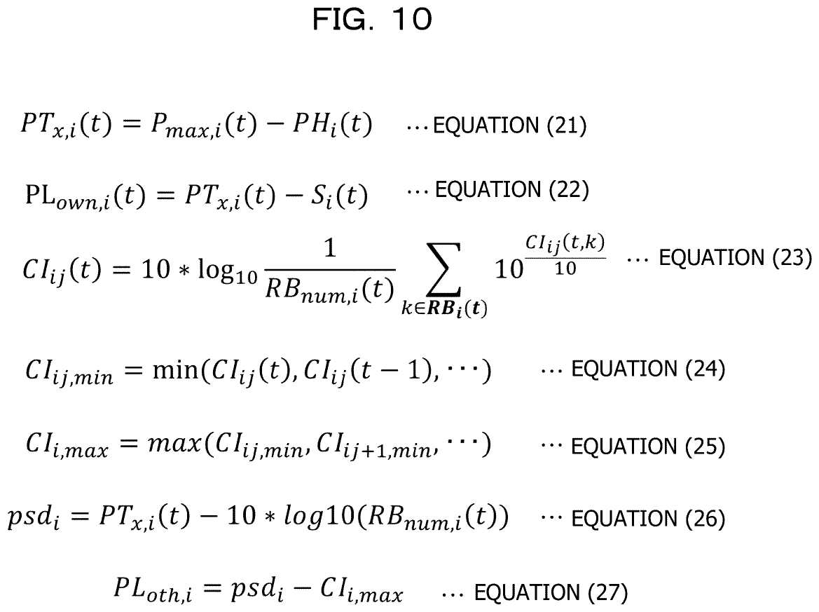

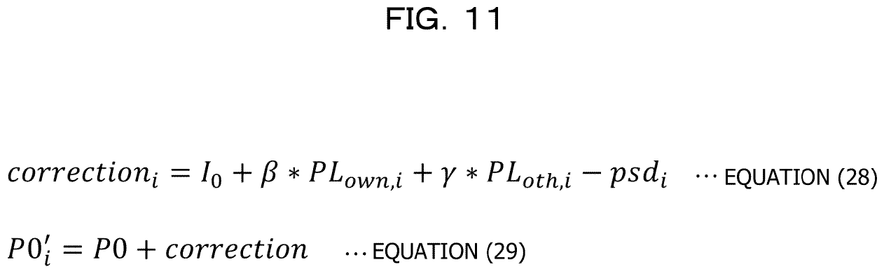

Hereinafter, the transmission power control in the entire wireless communication system including transmission output control processing S100 in the RIC 300 described above will be described. FIGS. 10 and 11 are diagrams illustrating examples of equations used in the transmission power control.

For example, the terminal apparatus 100 periodically transmits power headroom (PHR) to the base station apparatus 200. For example, the PHR includes information on a remaining transmission power of the terminal apparatus 100. The PHR is acquired, and thus, the base station apparatus 200 may control the transmission power of the terminal apparatus 100.

Upon receiving the PHR, the base station apparatus 200 calculates the transmission power of the terminal apparatus 100 by using Equation (21). PT_{x, i}(t) indicates a transmission output of the terminal apparatus 100-i at time t. PHᵢ(t) indicates a remaining transmission power of the terminal apparatus 100-i at time t. P_{max, i}(t) indicates a maximum transmission power of the terminal apparatus 100-i at time t. The base station apparatus 200 stores the transmission power of the terminal apparatus 100 in association with an identifier (UEID) of the terminal apparatus 100 and the time.

The base station apparatus 200 calculates a path loss for the own cell by using Equation (22). PL_{own, i}(t) indicates a path loss of the terminal apparatus 100-i for the own cell at time t. Si(t) indicates a received power of a Physical Uplink Shared Channel (PUSCH) or the like at the time of first transmission including the PHR from the terminal apparatus 100-i at time t. The base station apparatus 200 stores a path loss of the terminal apparatus 100 for the own cell in association with the identifier (UEID) of the terminal apparatus 100 and the time.

After performing the scheduling, the base station apparatus 200 stores a time at which a radio resource is allocated to the terminal apparatus 100, an identifier of a resource block, and the identifier of the terminal apparatus 100.

The base station apparatus 200 measures an interference power in communication, and stores a time, an identifier of a resource block, and an interference power corresponding to each resource block.

The base station apparatus 200 transmits these stored values to the RIC 300 and shares these values. For example, this sharing processing corresponds to processing of S100-2 in FIG. 9.

The RIC 300 calculates CIᵢⱼ at time t by using Equation (23). RB_{num, i}(t) indicates the number of resource blocks allocated to the terminal apparatus 100-i at time t. “RBᵢ(t)” indicates a set of resource blocks allocated to the terminal apparatus 100-i at time t. CIᵢⱼ(t, k) indicates an interference amount (interference power) of a resource block of which the identifier is k, which is received by the cell Cj at time t.

The RIC 300 calculates a minimum values CI_{ij, min} of the interference of each adjacent cell by using Equation (24).

The RIC 300 calculates a maximum value CI_{j, max} of the given interference by using Equation (25). Equation (25) is an equation for estimating the maximum given interference amount (maximum given interference power) from the minimum value of the interference in each adjacent cell.

The RIC 300 acquires a latest transmission power, a latest path loss for the own cell, and the number of used resource blocks of the terminal apparatus 100. For example, the RIC 300 acquires these values from the stored measurement data.

The RIC 300 calculates a transmission power psdᵢ per one resource block of the terminal apparatus 100 by using Equation (26).

The RIC 300 calculates a path loss PL_{oth, i} for the maximum given interference cell by using Equation (27). A series of processing of calculating the path loss for the maximum given interference cell corresponds to, for example, processing of S100-4 in FIG. 9.

The RIC 300 calculates a second corrected value (correctionᵢ) by using Equation (28). PL_{oth, i} used in Equation (28) is a path loss for the maximum given interference cell as described above.

The RIC 300 transmits the second corrected value to the base station apparatus 200. According to the second corrected value transmitted from the RIC 300, the base station apparatus 200 gives, to the terminal apparatus 100, a notification by using a TPC command so that the terminal apparatus 100 has a predetermined transmission power. Alternatively, the RIC 300 calculates a target received power P0′ after correction from the second corrected value by using Equation (29). The RIC 300 transmits the target received power after correction to the base station apparatus 200. The base station apparatus 200 notifies, by using a Radio Resource Control (RRC) reconfiguration or the like, the terminal apparatus 100 of the target received power after correction transmitted from the RIC 300, and performs control to achieve a predetermined transmission power.

### Modification Example

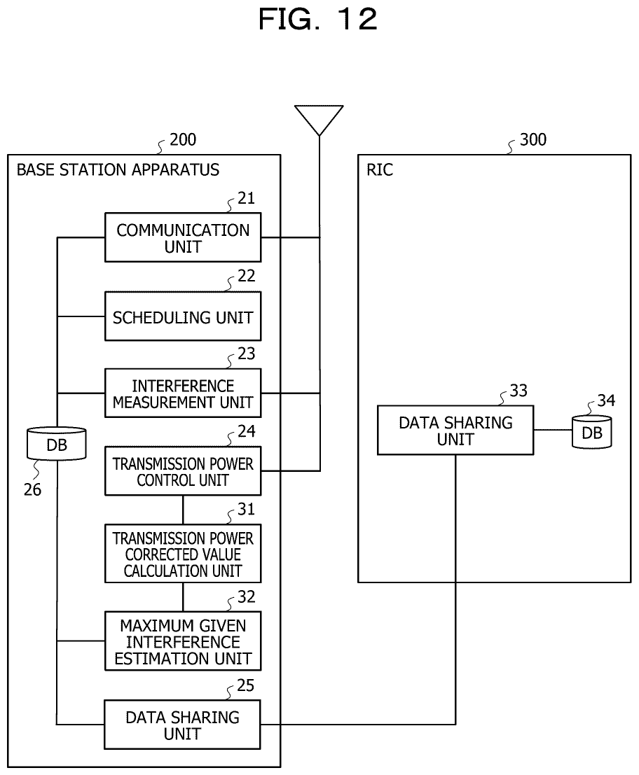

First, a modification example of the first embodiment will be described. FIG. 12 is a diagram illustrating an example of a software configuration of a wireless communication system 1 according to the modification example of the first embodiment.

In the modification example of the first embodiment, a base station apparatus 200 includes a transmission power corrected value calculation unit 31 and a maximum given interference estimation unit 32. The base station apparatus 200 estimates a maximum given interference and calculates a transmission power corrected value. As in the first embodiment, measurement data in each base station apparatus 200 is shared in a DB 34 via a data sharing unit 33 of an RIC 300.

### Second Embodiment

Next, a second embodiment will be described. In the second embodiment, a base station apparatus 200 uses measurement data in a terminal apparatus 100 and estimates a total sum of path losses for adjacent cells.

### [Software Configuration]

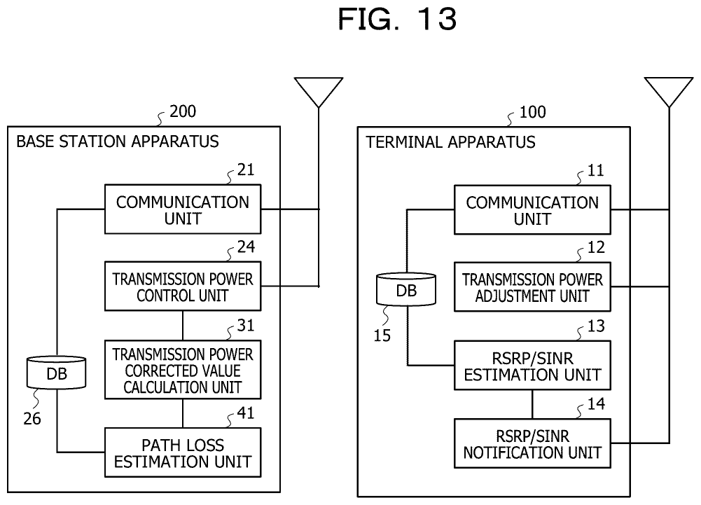

First, a software configuration of a wireless communication system 1 according to the second embodiment will be described. FIG. 13 is a diagram illustrating an example of the software configuration example of the wireless communication system 1 according to the second embodiment. It is assumed that the units are constructed by processors included in the base station apparatus 200 and the terminal apparatus 100 executing programs.

The base station apparatus 200 includes a communication unit 21, a transmission power control unit 24, a transmission power corrected value calculation unit 31, a path loss estimation unit 41, and a DB 26.

The base station apparatus 200 acquires measurement data from the terminal apparatus 100 via the communication unit 21, and stores the measurement data in the DB 26.

Based on the measurement data of the terminal apparatus 100, the path loss estimation unit 41 estimates a total sum of path losses for adjacent cells.

The transmission power corrected value calculation unit 31 calculates a second corrected value from the estimated total sum of path losses.

The terminal apparatus 100 includes a communication unit 11, a transmission power adjustment unit 12, a RSRP/SINR estimation unit 13, a RSRP/SINR notification unit 14, and a DB 15.

The communication unit 11 performs wireless communication with the base station apparatus 200.

The transmission power adjustment unit 12 adjusts a transmission power according to an instruction from the base station apparatus 200.

The RSRP/SINR estimation unit 13 receives signals from the base station apparatus 200, measures or calculates (estimates) RSRP and SINR, and stores the respective values in the DB 15.

The RSRP/SINR notification unit 14 notifies the base station apparatus 200 communicating with the terminal apparatus 100 of measurement data including the RSRP/SINR.

### [Second Corrected Value Calculation Method]

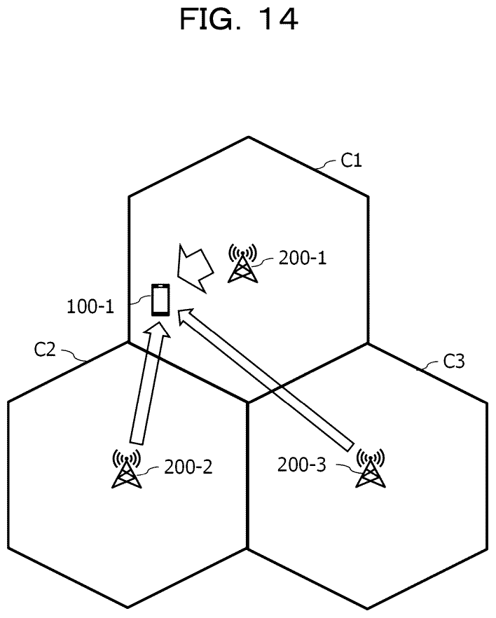

A method for calculating the second corrected value will be described. FIG. 14 is a diagram illustrating an example of radio wave measurement in the terminal apparatus 100-1 of the wireless communication system 1. As illustrated in FIG. 14, the terminal apparatus 100-1 is communicating with the base station apparatus 200-1, receives radio waves from adjacent base station apparatuses 200-2 and 200-3, and performs measurement. For example, the terminal apparatus 100-1 measures or calculates the RSRP or the SINR at the time of receiving a reference signal or a synchronization signal transmitted by the base station apparatus 200. The measurement data may include, in addition to the measured values, values calculated (estimated) based on the measured values or various kinds of data.

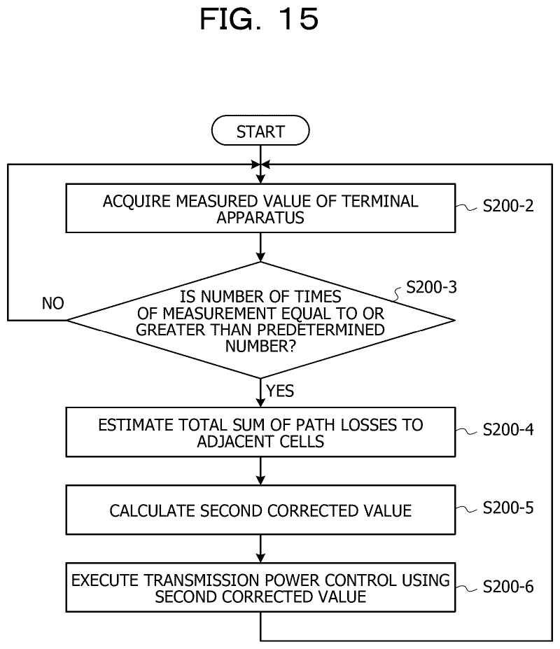

FIG. 15 is a diagram illustrating an example of a processing flowchart of transmission power control S200 in the base station apparatus 200.

For example, transmission output control processing S100 is processing executed after the OLTPC (Equation (1) in FIG. 5) is performed in the terminal apparatus 100, and is processing of performing corrected value calculation and notification.

The base station apparatus 200 acquires the measurement data of the terminal apparatus 100 in the own cell (S200-2). The measurement data is data stored in the terminal apparatus 100, and includes, for example, RSRP, SINR, and the like. For example, the measurement data is stored in association with a time. The base station apparatus 200 stores the acquired measurement data for each terminal apparatus 100 (in association with each other).

In a case where the number of times of measurement in the terminal apparatus 100 is not equal to or greater than a predetermined number of times (No in S200-3), the base station apparatus 200 waits for next measurement in the terminal apparatus 100 and acquires the measurement data (S200-2). The base station apparatus 200 repeats this processing until the number of times of measurement reaches the predetermined number of times.

In a case where the number of times of measurement in the terminal apparatus 100 is equal to or greater than the predetermined number of times (Yes in S200-3), the base station apparatus 200 estimates the total sum of path losses for the adjacent cells (S200-4).

The base station apparatus 200 calculates the second corrected value by using the estimated total sum of path losses (S200-5), and performs the transmission power control using the second corrected value (S200-6). Thereafter, the base station apparatus 200 periodically or non-periodically repeats this processing.

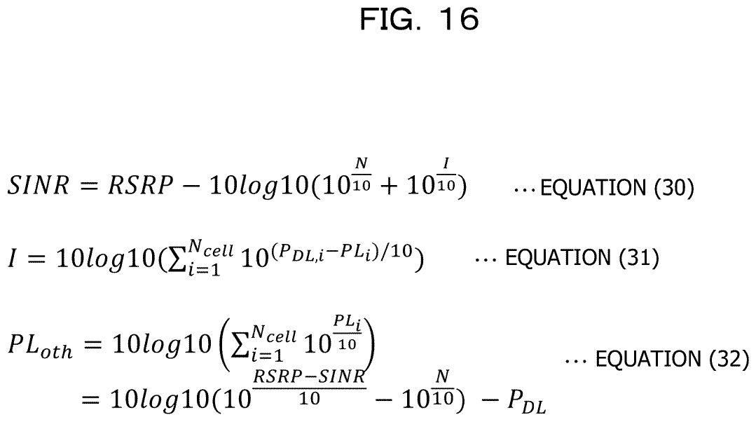

FIG. 16 is a diagram illustrating examples of equations used in the second corrected value calculation. The estimation of the total sum of path losses in the base station apparatus 200 will be described.

Based on the measurement data of the terminal apparatus 100, the base station apparatus 200 estimates a total sum PLₒₜₕ of path losses to the adjacent cells.

For example, the SINR may be represented by Equation (30) in dB notation. N indicates a thermal noise power, and I indicates an interference power.

The interference power I may be represented by, for example, Equation (31). N_{cell} indicates a total number of adjacent cells, and i indicates an identifier of the cell. PD_{L, i} indicates a downlink transmission power of the base station apparatus 200 having the cell identifier i. PLᵢ indicates a path loss between the base station apparatus 200 having the cell identifier i and the terminal apparatus 100.

Assuming that downlink transmission powers of the cells are the same, PLₒₜₕ may be represented by Equation (32).

As described above, the total sum of path losses may be estimated from the RSRP, the SINR, the thermal noise power, and the downlink transmission power. By using the estimated total sum of path losses, the base station apparatus 200 calculates the transmission power corrected value, for example, by using Equation (3).

It is assumed that a value at a normal temperature is used as the thermal noise power, and a value of the own cell (the base station apparatus 200) is used as the downlink transmission power.

### Modification Example

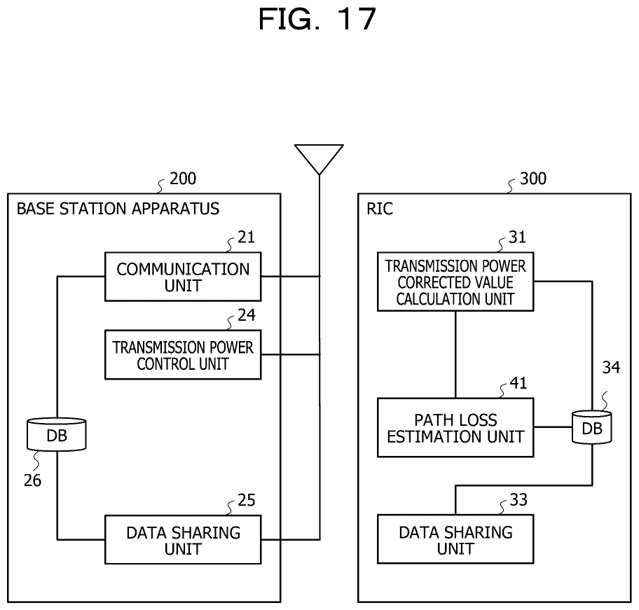

A modification example of the second embodiment will be described. FIG. 17 is a diagram illustrating an example of a software configuration of a wireless communication system 1 according to the modification example of the second embodiment. A software configuration of a terminal apparatus 100 is similar to that of the second embodiment, and thus, description thereof will be omitted.

In the modification example of the second embodiment, an RIC 300 includes a transmission power corrected value calculation unit 31 and a path loss estimation unit 41. The RIC 300 performs estimation of the total sum of path losses and calculation of a transmission power corrected value. As in the first embodiment, measurement data stored in each base station apparatus 200 (measurement data of the terminal apparatuses 100) is shared in a DB 34 via a data sharing unit 33 of the RIC 300.

In the modification example, the measurement data is shared in the RIC 300, for example, and thus, a calculation cost reduction effect in the base station apparatus 200 may be achieved and multi-vendor by using an open interface may be coped with.

### OTHER EMBODIMENTS

In each of the embodiments, the RIC 300 may be either “Non-Real Time RIC” or “Near-Real Time Intelligent Controller (RIC)”.

To implement each embodiment, for example, interfaces (information elements) to be described below are added.

[Information Element from Base Station Apparatus 200 to RIC 300]
Transmission power information: The identifier, time, and transmission power of the terminal apparatus 100 are included.
Path loss information: The identifier, time, and path loss of the terminal apparatus 100 are included.
Scheduling information: The identifier of the terminal apparatus 100, the identifier of the resource block, and time are included.
Interference information: The identifier of the base station apparatus, time, and the identifier of the resource block, and interference power are included. [Information Element from RIC 300 to Base Station Apparatus 200]
Transmission power corrected value information: The identifier, a transmission power corrected value (including second corrected value) of the terminal apparatus 100 or a transmission output in consideration of the transmission power corrected value are included.

For example, the information element is added in the E2 interface, the A1 interface, or an O1 interface in FIG. 3.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A control device in a communication system that includes a plurality of base station apparatuses each to constitute a cell, and a terminal apparatus to perform wireless communication with the base station apparatus when the terminal apparatus is positioned in the cell, the control device controlling the base station apparatuses, the control device comprising:
a memory; and
processor circuitry coupled to the memory and configured to:
acquire, from the base station apparatus, an interference value measured when a signal is received from the terminal apparatus by the base station apparatus;
estimate, when a transmission power of a first terminal apparatus that communicates with a first base station apparatus of the plurality of base station apparatuses is controlled in accordance with a value of a path loss for the first base station apparatus, a maximum given interference amount which is a maximum amount, among given interferences of the first terminal apparatus for an other base station apparatus other than the first base station apparatus; and
acquire a corrected value for correcting the transmission power of the first terminal apparatus by using the maximum given interference amount.

2. The control device according to claim 1, wherein the processor circuitry is configured to regard, when the maximum given interference amount is a given interference for a second base station apparatus, a total sum of given interferences for the second base station apparatus as the maximum given interference amount, acquire a total sum of path losses for the second base station apparatus from the total sum of given interferences for the second base station apparatus, and acquire the corrected value by using the total sum of path losses.

3. The control device according to claim 1,
wherein the communication system is defined by an open interface, and
wherein the processor circuitry is configured to include a near-real time RAN intelligent controller (RIC).

4. The control device according to claim 1,
wherein the communication system is defined by an open interface, and
wherein the processor circuitry is configured to include a non-real time RAN intelligent controller (RIC).

5. The control device according to claim 1, wherein the transmission power is controlled by using open-loop transmission power control (OLTPC).

6. The control device according to claim 3, wherein, in the open interface, the communication between the base station apparatus and the control device is performed by using any one of an E2 interface, an O1 interface, and an A1 interface.

7. A control method of a control device in a communication system that includes a plurality of base station apparatuses each to constitute a cell, and a terminal apparatus to perform wireless communication with the base station apparatus when the terminal apparatus is positioned in the cell, the control device controlling the base station apparatuses, the control method comprising:
acquiring, from the base station apparatus, an interference value measured when a signal is received from the terminal apparatus by the base station apparatus;
estimating, when a transmission power of a first terminal apparatus that communicates with a first base station apparatus of the plurality of base station apparatuses is controlled in accordance with a value of a path loss for the first base station apparatus, a maximum given interference amount which is a maximum amount, among given interferences of the first terminal apparatus for an other base station apparatus other than the first base station apparatus; and
acquiring a corrected value for correcting the transmission power of the first terminal apparatus by using the maximum given interference amount, by processor circuitry.

8. A base station apparatus in a communication system that includes a plurality of base station apparatuses each to constitute a cell, and a terminal apparatus to perform wireless communication with the base station apparatus when the terminal apparatus is positioned in the cell, and that controls a transmission power in accordance with a value of a path loss for the base station apparatus which is communicating with the terminal apparatus, the base station apparatus comprising:
a memory; and
processor circuitry coupled to the memory and configured to:
acquire measurement data measured when a signal is received from the base station apparatus by the terminal apparatus; and
estimate, when a transmission power of the terminal apparatus which is communicating with the base station apparatus is controlled, a total sum of path losses for an other base station apparatus of the plurality of base station apparatuses that include a path loss of the terminal apparatus for the other base station apparatus by using the measurement data, and acquire a corrected value for correcting the transmission power of the terminal apparatus by using the estimated total sum of path losses.

9. The base station apparatus according to claim 8, wherein the measurement data includes a received power of the signal and a signal-to-interference noise ratio calculated from the received power.

10. The base station apparatus according to claim 9, wherein, in the estimating, the processor circuitry is configured to calculate an interference amount by using a thermal noise power, and estimate the total sum of path losses by using the calculated interference amount.
